(19) United States
(12) Patent Application Publication
(10) Pub. No.: US 2016/0276793 A1
(43) Pub. Date: Sep. 22, 2016

(54) METHOD FOR CRIMPING ELECTRICAL WIRE TO TERMINAL

(71) Applicant: YAZAKI CORPORATION, Tokyo (JP)

(72) Inventor: Yutaka TERASAKA, Shizuoka (JP)

(73) Assignee: YAZAKI CORPORATION, Tokyo (JP)

(21) Appl. No.: 15/171,438

(22) Filed: Jun. 2, 2016

Related U.S. Application Data
(63) Continuation of application No. PCT/JP2014/081724, filed on Dec. 1, 2014.

(30) Foreign Application Priority Data
Dec. 3, 2013 (JP) 2013-249813

(51) Int. Cl. H01R 43/048; H01R 4/18

(52) U.S. Cl. CPC H01R 43/048; H01R 4/183

(57) ABSTRACT

When a crimped structure of an electrical wire to a terminal is formed with an electrical wire crimped to a crimp terminal fitting, first, a coating on a leading end of the electrical wire is peeled off to expose core wires, and the leading ends of the core wires are processed into a conical shape so as to be tapered over the entire circumference to form a tapered part. Next, the electrical wire is arranged in an electrical wire barrel such that the core wires of the electrical wire with the coating peeled off are accommodated in a core wire barrel. At this time, a bottom of the conical shape on the leading ends of the core wires is adapted to be accommodated in the core wire barrel. The core wires are swaged by a crimping piece of a core wire crimping part.

### CROSS REFERENCE TO RELATED APPLICATIONS

This application is a Continuation of PCT Application No. PCT/JP2014/081724 filed on Dec. 1, 2014, and claims the priority of Japanese Patent Application No. 2013-249813 filed on Dec. 3, 2013, the content of both of which is incorporated herein by reference.

### TECHNICAL FIELD

The present invention relates to a method fort crimping an electrical wire to a terminal.

### BACKGROUND ART

As the method for crimping the electrical wire to the terminal, such a method as follows is disclosed in the undermentioned Patent Literature 1. First, leading ends of core wires obtained by peeling the electrical wire are inclined relative to a central axial direction of the core wires and are cut off. Subsequently, it is arranged in a barrel such that an inclined section is oriented toward the open-end side of the barrel and the barrel is swaged. In Patent Literature 1, the electrical wire is crimped to the terminal in this way.

### CITATION LIST

### Patent Literature

Patent Literature 1: Japanese Patent Laid-Open Publication No. 2010-61871

### SUMMARY OF INVENTION

### Technical Problem

However, in the above-mentioned method, when the electrical wire is to be arranged in the barrel in a crimping process, it is necessary to arrange it by determining the orientation of the electrical wire such that the inclined section of the core wires is oriented toward the open-end side of the barrel and it is necessary to accurately perform positioning of the electrical wire. Therefore, it has caused complication of the crimping process.

The present invention aims to provide a method for crimping an electrical wire to a terminal which can solve the above-mentioned problem.

### Solution to Problem

In order to attain such an object, the method for crimping the electrical wire to the terminal of the present invention is a method for forming a tapered part by processing leading ends of peeled-off core wires of the electrical wire so as to be tapered over the entire circumference; and crimping the electrical wire to the terminal.

The present invention may be characterized in that the electrical wire is crimped to the terminal with the electrical wire arranged in a barrel such that an end of the tapered part is accommodated in the barrel of the terminal.

The present invention may be characterized in that the leading ends of the peeled-off core wires of the electrical wire are processed into a stepped shape over the entire circumference to form the tapered part.

### BRIEF DESCRIPTION OF DRAWINGS

FIG. 1A is a diagram showing a crimped structure of an electrical wire to a terminal of one embodiment of the present invention, and is a plan view of the crimped structure of the electrical wire.

FIG. 1B is a diagram showing a crimped structure of an electrical wire to a terminal of one embodiment of the present invention, and is a side view of the crimped structure of the electrical wire.

FIG. 2 is a first diagram showing a method for crimping the electrical wire to a crimp terminal fitting.

FIG. 3 is a second diagram showing the method for crimping the electrical wire to the crimp terminal fitting.

FIG. 4 is a third diagram showing the method for crimping the electrical wire to the crimp terminal fitting.

FIG. 5 is a fourth diagram showing the method for crimping the electrical wire to the crimp terminal fitting.

FIG. 6 is a fifth diagram showing the method for crimping the electrical wire to the crimp terminal fitting.

FIG. 7 is a diagram showing a comparative example of the method for crimping the electrical wire to the crimp terminal fitting.

FIG. 8 is a diagram showing an altered example of the electrical wire.

### DESCRIPTION OF EMBODIMENTS

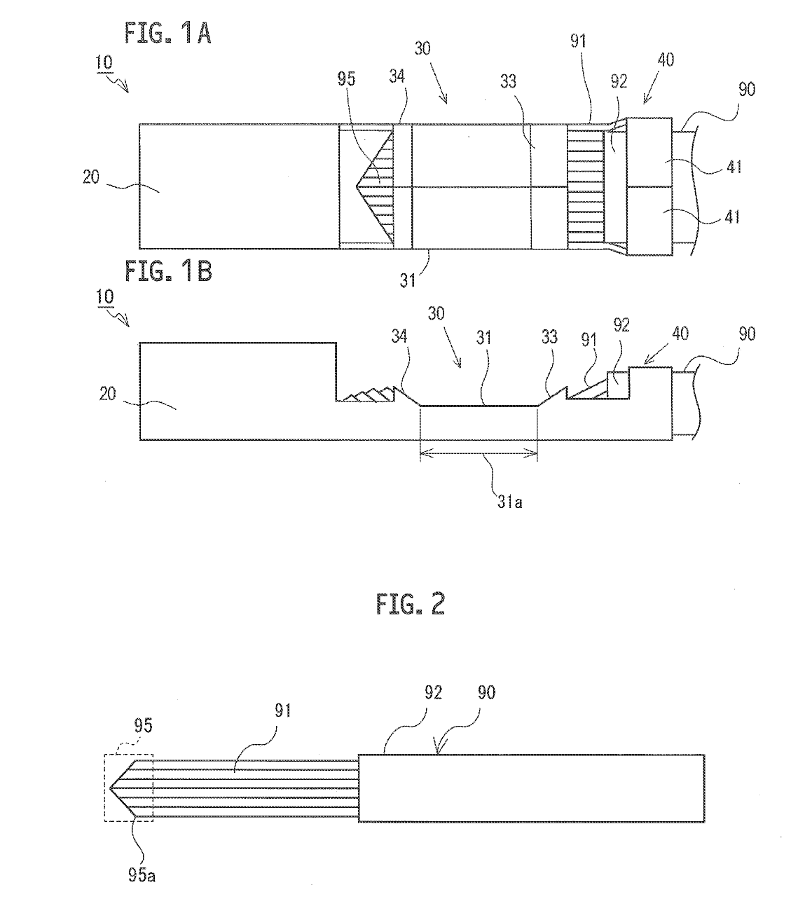

In the following, one embodiment of the present invention will be described with reference to the drawings. FIG. 1A and FIG. 1B are diagrams showing a crimped structure of an electrical wire to a terminal of one embodiment of the present invention, in which FIG. 1A is a plan view of the crimped structure of the electrical wire and FIG. 1B is a side view of the crimped structure of the electrical wire.

The crimped structure of the electrical wire to the terminal of the present embodiment is configured by swaging an electrical wire 90 by a crimp terminal fitting (10) as shown in FIG. 1A and FIG. 1B.

The crimp terminal fitting 10 is formed by punching and bending an electro-conductive substrate and is configured by an electrical contact part 20, a core wire barrel 30, and an electrical wire barrel 40.

The electrical contact part 20 is a box-shaped female die in which one longitudinal-direction side (shown on the left side) is opened. An electrical contact part of the crimp terminal fitting which is a male die is inserted into the electrical contact part 20.

The electrical wire barrel 40 is swaged by a terminal crimping machine and is crimped with a coating 92 in a state where the coating 92 of the electrical wire 90 is accommodated therein.

In addition, the core wire barrel 30 is formed between the electrical contact part 20 and the electrical wire barrel 40. The core wire barrel 30 is swaged by the terminal crimping machine and is crimped with core wires 91 in a state where the core wires 91 of the electrical wire 90 with the coating 92 peeled off are accommodated therein.

A central part of a crimping piece 31 of the core wire barrel 30 constitutes a perfect compression part 31a an upper surface of which is formed almost horizontally. In the perfect compression part 31a, the core wires 91 are swaged by the crimping piece 31 and are in a perfectly compressed state. A rear-side bell-mouth part 33 and a front-side bell-mouth part 34 which are excess thickness parts are formed on the both sides of the perfect compression part 31a.

The rear-side bell-mouth part 33 and the front-side bell-mouth part 34 are parts where the crimping piece of 31 the core wire barrel 30 is not perfectly swaged by the terminal crimping machine and are in a state where the core wires 91 are not perfectly compressed by the crimping piece 31. For this reason, upper surfaces of a rear-side part and a front-side part of the crimping piece 31 of the core wire barrel 30 are extended upward from the perfect compression part 31a on the rear-side bell-mouth part 33 and the front-side bell-mouth part 34.

As shown in FIG. 1B, leading end parts of the core wires 91 are extended from the front-side bell-mouth part 34 obliquely upward. As shown in FIG. 2, the peeled leading ends of the core wires 91 of the electrical wire 90 are processed into a conical shape over the entire circumference and a tapered part 95 is provided thereon. That is, the tapered part 95 is almost axially symmetric around a central axis of the core wire 91 and has a shape that the diameter thereof is reduced as it approaches ends of the core wires 91.

In the present embodiment, the tapered part 95 has the conical shape having a curved surface which is obtained by rotating a line segment which is inclined neither in parallel with nor vertically to the central axis of the core wire 91 relative to the central axis of the core wire 91.

Since the tapered part 95 has the conical shape, the lengths of the core wires 91 projected from the tip of the front-side bell-mouth part 34 are gradually shortened from an up-down direction central part toward the upper surface side of the crimping piece 31. Likewise, the lengths of the core wires 91 projected from the tip of the front-side bell-mouth part 34 are gradually shortened from the up-down direction central part toward the lower surface side of the crimping piece 31. The lengths of the core wires 91 projected from the tip of the front-side bell-mouth part 34 become longer as it approaches the central axis of the core wire 91 from the side of coated surface of the core wire 91.

The entire of a crimping piece 41 of the electrical wire barrel 40 is perfectly swaged by the terminal crimping machine and the coating 92 is in a state of being perfectly compressed together with the core wires 91 by the crimping piece 41. Therefore, the coating 92 which is tightened by the crimping piece 41 of the electrical wire barrel 40 deforms and the excess thickness part is formed on the part projected from the crimping piece 41.

Next, a method for crimping the electrical wire 90 to the crimp terminal fitting 10 and forming the crimped structure of the electrical wire to the terminal will be described.

When the electrical wire 90 is to be crimped to the crimp terminal fitting 10, first, as shown in FIG. 2, peeling is performed by stripping off the coating 92 on the leading ends of the electrical wires 90 so as to expose the leading ends of the core wires 91. Thereafter, the tapered part 95 is provided on the leading ends of the core wires 91 by processing the leading ends of the core wires 91 into the conical shape over the entire circumference. This processing is performed by continuously cutting the peeled leading ends of the core wires 91 on a surface inclined relative to a central axis direction of the core wire 91 over the entire circumference.

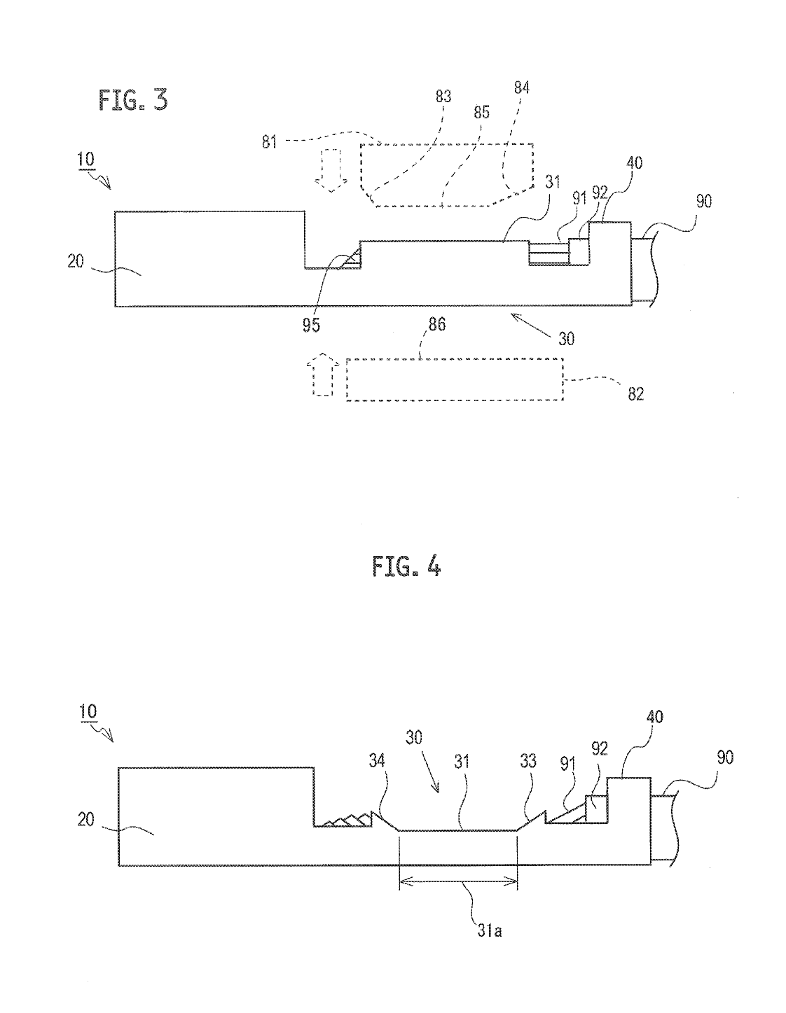

Next, as shown in FIG. 3, the electrical wire 90 is arranged in the electrical wire barrel 40 such that the core wires 91 with the coating 92 of the electrical wire 90 peeled off are accommodated in the core wire barrel 30. At this time, a bottom 95a of the tapered part 95 is adapted to be accommodated in the core wire barrel 30.

Subsequently, as shown in FIG. 3, the crimping piece 31 of the core wire barrel 30 is arranged between an upper crimping die 81 and a lower crimping die 82 of the terminal crimping machine, and the core wire barrel 30 is swaged by the upper crimping die 81 and the lower crimping die 82. The upper crimping die 81 is provided with tapered parts 83, 84 at front and rear end parts of a crimping surface 85. On the other hand, a crimping surface 86 is formed so as to be flush with the lower crimping die 82.

For this reason, when the core wire barrel 30 is swaged by the upper crimping die 81 and the lower crimping die 82, the above-mentioned rear-side bell-mouth part 33 and front-side bell-mouth part 34 are formed on the crimping piece 31 as shown in FIG. 4.

In addition, as shown in FIG. 4, the leading ends of the core wires 91 are bent and are obliquely extended upward from the front-side bell-mouth part 34. In the present embodiment, since the leading ends of the core wires 91 are processed into the conical shape over the entire circumference, no matter in which direction the electrical wire 90 is oriented, the lengths of the core wires 91 projected from the tip of the front-side bell-mouth part 34 are gradually shortened from the up-down direction central part toward the upper surface side of the crimping piece 31 as shown in FIG. 4.

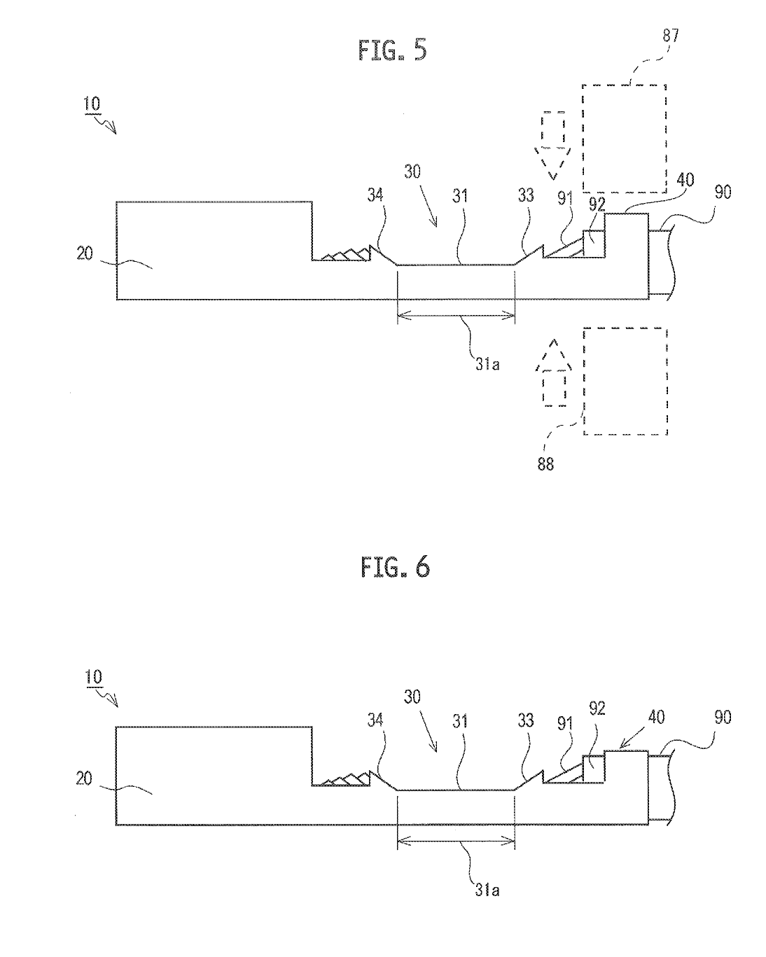

Subsequently, as shown in FIG. 5, the crimping piece 41 of the electrical wire barrel 40 is arranged between an upper crimping die 87 and a lower crimping die 88 of the terminal crimping machine, and the electrical wire barrel 40 is swaged by the upper crimping die 87 and the lower crimping die 88. When the electrical wire barrel 40 is swaged by the upper crimping die 87 and the lower crimping die 88, the coating 92 which is tightened by the crimping piece 41 deforms and the excess thickness parts are formed on the parts projected from the crimping piece 41 as shown in FIG. 6.

The effect attained by providing the tapered part 95 by processing the leading ends of the core wires 91 will become apparent from comparison with a case where an electrical wire which is processed with the leading ends of the core wires 91 lined up is crimped (that is, the case of not providing the tapered part 95).

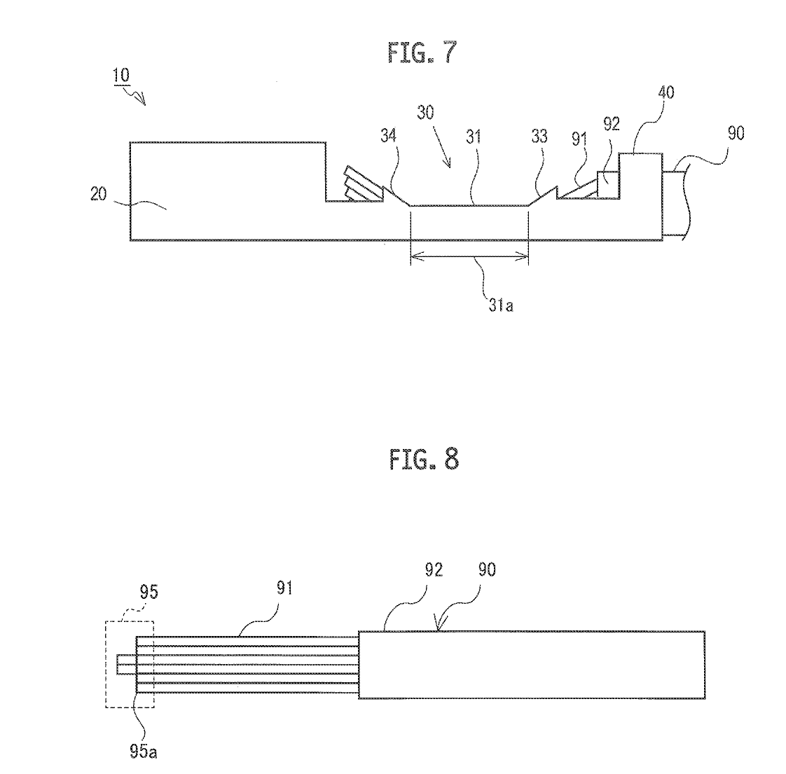

FIG. 7 is a diagram showing a comparative example for comparison with the present embodiment and shows the case where the electrical wire which is processed with all the leading ends of the core wires 91 lined up is crimped (that is, the case of not providing the tapered part 95). When crimping the core wires 91 by the core wire barrel 30, the core wires 91 deform with crimping force applied from the core wire barrel 30 and, in the core wires 91, parts projected from the core wire barrel 30 largely flip up. Therefore, as shown in FIG. 7, the core wires 91 which have projected from the tip of the front-side bell-mouth part 34 are extended exceeding the height of the front-side bell-mouth part 34.

However, according to the present embodiment, since the tapered part 95 is provided on the leading ends of the core wires 91 by processing the leading ends of the peeled core wires 91 of the electrical wire 90 into the conical shape over the entire circumference, the lengths of the parts which flip up when crimped are formed short. For this reason, even in a case where flipping-up of the core wires 91 occurs, projection of the core wires 91 from the tip of the front-side bell-mouth part 34 is restrained as shown in FIG. 4. Thereby, sticking-out of the core wires 91 from the core wire barrel 30 can be prevented.

Since when the electrical wire 90 is inserted into the crimp terminal fitting 10, the electrical wire 90 freely rotates around its central axis, there is the possibility that the electrical wire 90 may be inserted into the crimp terminal fitting 10 in a state of being oriented in various directions. However, in the present embodiment, since the tapered part 95 is provided on the leading ends of the core wires 91 by processing, no matter in which direction the electrical wire 90 is oriented, sticking-out of the core wires 91 from the core wire barrel 30 can be prevented as shown in FIG. 4. For this reason, positioning of the electrical wire 90 becomes unnecessary and work of crimping the electrical wire 90 to the crimp terminal fitting 10 can be facilitated.

Incidentally, although in the above-mentioned embodiment, description has been made on the case where the tapered part 95 has the conical shape in which the angle of inclination of the conical shape (that is, an angle made by a generatrix of a conical surface which is present on a side face of the conical shape and the central axis of the core wire 91) has a predetermined value, if it takes a form that the leading ends of the peeled core wires 91 of the electrical wire 90 are processed into the conical shape over the entire circumference, the angle of inclination of the conical shape can be optionally selected.

In addition, although in the above-mentioned embodiment, description has been made on the case where the front-side bell-mouth part 34 and the rear-side bell-mouth part 33 are provided on the both sides of the perfect compression part 31a, it may also take a configuration that the front-side bell-mouth part 34 and the rear-side bell-mouth part 33 are not provided. Also in this configuration, no matter in which direction the electrical wire 90 is oriented, sticking-out of the core wires 91 from the core wire barrel 30 can be prevented by providing the tapered part 95 by processing the leading ends of the peeled core wires 91 of the electrical wire 90 into the conical shape over the entire circumference and the same effect as that of the above-mentioned embodiment can be obtained.

In addition, in the above-mentioned embodiment, description has been made on the case where the electrical wire 90 is arranged in the electrical wire barrel 40 such that the bottom 95a of the tapered part 95 of the core wires 91 is accommodated in the core wire barrel 30 of the crimp terminal fitting 10. However, the electrical wire 90 need not necessarily be arranged such that the tapered part 95 is accommodated in the core wire barrel 30 of the crimp terminal fitting 10, and the tapered part 95 may be arranged outside the core wire barrel 30.

In addition, although in the above-mentioned embodiment, description has been made on the case where the tapered part 95 is provided by processing the leading ends of the core wires 91 into the conical shape over the entire circumference, it will be good if the tapered part 95 is provided on the leading ends of the core wires 91 by processing such that the leasing ends of the peeled core wires 91 of the electrical wire 90 are tapered over the entire circumference, and the shape of the tapered part 95 is optional. For example, as shown in FIG. 8, the tapered part may be provided on the leading ends of the core wires 91 by processing the leading ends of the peeled and exposed core wires 91 of the electrical wire 90 into a stepped shape over the entire circumference.

Also by this configuration, no matter in which direction the electrical wire 90 is oriented, the lengths of the core wires 91 projected from the tip of the front-side bell-mouth part 34 become shorter on the upper surface side than on the up-down direction central part of the crimping piece 31. Therefore, no matter in which direction the electrical wire 90 is oriented, sticking-out of the core wires 91 from the core wire barrel 30 can be prevented. For this reason, the work of crimping the electrical wire 90 to the crimp terminal fitting 10 can be facilitated.

Although, in the foregoing, the embodiments of the present invention have been described, these embodiments are mere illustrations which have been described for easy understanding of the present invention and the present invention is not limited to the embodiments concerned. The technical scope of the present invention is not limited to the specific technical matters which have been disclosed in the above-mentioned embodiments and also include various modifications, alterations, alternative technologies which can be easily derived from them.

### INDUSTRIAL APPLICABILITY

According to the present invention, the leading ends of the peeled core wires of the electrical wire are processed to be tapered over the entire circumference. Therefore, no matter in which direction the electrical wire is oriented, sticking-out of the core wires from the barrel can be prevented and the work of crimping the electrical wire to the terminal can be facilitated.

### REFERENCE SIGNS LIST

10 crimp terminal fitting

20 electrical contact part

30 core wire barrel

31 crimping piece

31a perfect compression part

33 rear-side bell-mouth part

34 front-side bell-mouth part

40 electrical wire barrel

81 upper crimping die

82 lower crimping die

83, 84 tapered part

85 crimping surface

86 crimping surface

90 electrical wire

91 core wire

92 coating

1. A method for crimping an electrical wire to a terminal, comprising:
forming a tapered part by processing leading ends of peeled-off core wires of the electrical wire so as to be tapered over the entire circumference; and
crimping the electrical wire to the terminal.

2. The method for crimping the electrical wire to the terminal according to claim 1, wherein
the electrical wire is crimped to the terminal with the electrical wire arranged in a barrel such that a bottom of the tapered part is accommodated in the barrel of the terminal.

3. The method for crimping the electrical wire to the terminal according to claim 1, wherein
the leading ends of the peeled-off core wires of the electrical wire are processed into a stepped shape over the entire circumference to form the tapered part.

4. The method for crimping the electrical wire to the terminal according to claim 1, wherein
the leading ends of the peeled-off core wires of the electrical wire are processed into a conical shape over the entire circumference to form the tapered part.

5. The method for crimping the electrical wire to the terminal according to claim 2, wherein
the leading ends of the peeled-off core wires of the electrical wire are processed into a stepped shape over the entire circumference to form the tapered part.

6. The method for crimping the electrical wire to the terminal according to claim 2, wherein
the leading ends of the peeled-off core wires of the electrical wire are processed into a conical shape over the entire circumference to form the tapered part.
